(19) United States
(12) Patent Application Publication
(10) Pub. No.: US 2007/0297272 A1
(43) Pub. Date: Dec. 27, 2007

(54) Method for Mixing a Plastic Granulate With an Additive and Mixing Device for Carrying Out Said Method and Device Provided With Said Mixing Device

(76) Inventor: Werner Kempter, St. Margrethen (CH)

Correspondence Address: MORRISS OBRYANT COMPAGNI, P.C., 734 EAST 200 SOUTH, SALT LAKE CITY, UT, 84102, US

(21) Appl. No.: 11/658,972

(22) PCT Filed: Jul. 29, 2005
(86) PCT No.: PCT/CH05/00455

§ 371 Date: Feb. 26, 2007

(30) Foreign Application Priority Data
Jul. 30, 2004 (CH) 1290/04

(51) Int. Cl. C08J 3/20; B29B 7/78; B29C 47/10

(52) U.S. Cl. 366/76.9

(57) ABSTRACT

The invention relates to a method and to a mixing device (15), wherein an injection device (39) is arranged in a preferably tubular passageway (37) and the outlet of the injection device (39) is oriented in the direction of flow of the bulk material. Said arrangement enables efficient and even wetting of a free-flowing bulk material with a liquid.

### FIELD OF THE INVENTION

The invention relates to a method and a mixing device in accordance with the preamble to claims 1 and 5, and also relates to an apparatus for producing extruded products made of polymers having said mixing device in accordance with claim 10.

### PRIOR ART

EP-A-695 320 relates to a method for producing a cross-linked, extruded polymer product, whereby the polymer to be cross-linked, which has a fissured surface, is processed with liquid additives by extrusion in a continuous casting apparatus. In the method described, a liquid additive that is added via a feeding device and that is for cross-linking is mixed with the polymer. The additive is added between a feed apparatus for the polymer and the continuous casting apparatus. In an apparatus for performing the method, a mixer is arranged between a feeding hopper for receiving a polymer granulate/polymer powder and a screw extruder. A feed line for a liquid additive, which line comes from a metering pump unit, opens into the mixer. A nozzle arranged on the mixer makes it possible to inject the liquid additive that has been transported through the feed line into the mixer. The described apparatus is designed for a continuous operation in which granulate and additive are added continuously.

DE-OS 26 31 622 discloses a method and an apparatus for simultaneous and continues addition of liquids and powder so s to treatment machines. The liquid is shaped into a hose-like jacket into the center of which the so is added. In accordance with one exemplary embodiment, arranged in the narrowest cross-section of a funnel-shaped feeding device for pourable solids is a tapered nozzle that is connected to a liquid feed line. The pourable solids pass through the liquid jacket in the area of the narrowest cross-section and, as a largely closed stream of solids, pour into the feed opening of a mixer without touching the interior wall of the feed tube. The objective of DE-OS-36 31 622 is to prevent caking and clogs without it being necessary to use mechanical aids.

U.S. Pat. No. 5,626,422 discloses an apparatus and a method for producing a homogenous solution of a powder in a liquid. In a first step, a powder and a liquid are fed simultaneously into a mixer by a powder/liquid delivery apparatus, the contact between liquid and powder to be minimized prior to their entering the mixer. Provided for attaining the object is a powder/liquid delivery apparatus comprising a cylindrical tube segment and a funnel that connects thereto. The liquid is fed by means of a first and a second feed line. The first feed line is embodied as a ring nozzle that is arranged in the upper section of the cylindrical tube segment and that wets the interior surface of the adapter. The second feed line for the liquid is positioned in the funnel excentrically above the funnel opening. In operation, 90% of the liquid is fed through the second feed line. The powder is fed through a tube, that has a narrow cross-section and whose outlet is arranged above and concentric with the funnel opening, into the powder/liquid delivery apparatus. The liquid and the powder are mixed a high-intensity mixer connected to the funnel opening. The goal of U.S. Pat. No. 5,626,422 is to prevent clumps from forming prior to the entry into the high-intensity mixer.

### OBJECT OF THE INVENTION

The object of the present invention is to provide a method and mixing device that permit thorough mixing of a liquid additive with a plastic granulate. Another goal is to suggest a mixing device that makes it possible to separate the feeding device from the continuous casting apparatus. The suggested mixing device should be robust and cost-effective to produce.

Specification

In accordance with the invention, the object is attained using a method in accordance with the preamble to claim 1 in that the outlet of the injection apparatus is arranged above a funnel-shaped guide piece. This method has the advantage that good and uniform wetting of the bulk material is attained. In addition, it can be employed with already existing systems when an appropriate mixer is retrofitted. One application of the inventive method is for instance wetting a plastic granulate with an additive, e.g., silane, in a reactive continuous casting method.

Preferably the bulk material is fed through a gap, preferably an annular gap, provided in the passage. For this purpose, the injection device is preferably arranged such that a gap for the bulk material to pass through is present between the injection apparatus and the tube segment. This has the advantage that a continuous curtain of bulk material is formed that pours down or falls on the interior surface of the mixer. This creates a large bulk material surface area that is easy to wet. In addition, very good penetration of the bulk material with liquid is attained. Another surprising advantage is that no caking occurs and thus smooth operation is possible. Advantageously, the width of the annular gap is set as a function of the physical parameters of the liquid (viscosity, temperature, surface tension, etc.) and the bulk material (grain size, distribution of the grain sizes, etc.). This permits precise adjustment of the desired wetting.

The subject matter of the present invention is also a mixing device in accordance with the preamble to claim 5 that is characterized in that provided in the passage of the mixing device is a funnel-shaped guide piece and the outlet of the injection apparatus is arranged above the funnel-shaped guide piece. This mixing device has the advantage that the bulk material spreads out below the outlet of the injection apparatus (e.g. seen in the direction of flow after the outlet of the injection apparatus) and is conveyed along such that it is possible to spray the bulk material directly. Since the bulk material is present as a practically continuous curtain, almost no liquid strikes the interior surface of the tube segment so that there is no caking of the bulk material. Advantageous embodiments are defined in the subordinate claims.

A gap for the bulk material to pass through is advantageously present between the injection device and the jacket of the tube segment. Uniform distribution (separation) and thus wetting of the bulk material is enabled due to the bulk material being forced to pass through the gap. One particularly advantageous embodiment provides that an annular gap for the bulk material to pass through is present between the injection device and the tube segment. The annular gap preferably has a width between 5 and 30 mm and particularly preferably has a width between 10 and 20 mm. In the preferred embodiment, the tube segment is cylindrical and the core at which the injection nozzle is arranged has a circular cross-section so that an annular gap is present between the tube segment and the core.

In accordance with one advantageous embodiment, a preferably funnel-shaped guide piece is provided below the injection apparatus. This has the advantage that the bulk material trickling film spreads out under the injection nozzle and is conveyed past. Usefully, the guide piece can be displaced in the tube segment. This has the advantage that the flow-through quantity is adjustable. The core and the guide piece can preferably be moved from an open position relative to one another, in which an annular gap is formed between the tube segment with respect to the guide piece and the core, to a closed position, in which the guide piece is positioned against the core and the passage for the bulk material is blocked, and vice versa. This has the advantage that the width of the annular gap can be modified and consequently the quantity of bulk material flowing through the gap per unit of time and its flow speed can be varied. In addition, it is possible to isolate the interior space of the mixing device from the surrounding environment. Thus if there is an interruption to operations, if the mixing device is closed upstream of the injection nozzle as seen in the direction of flow, no toxic vapors can travel into the surrounding environment.

The subject matter of the present invention is also an apparatus for producing extruded products made of polymers, in particular polymer granulate, having
a mixing device in accordance with any of claims 5 through 9;
a feeding device for at least one polymer, which device is provided on or connected to the inlet of the first connection side of the mixing device; and,
a continuous casting apparatus that is provided on or connected to the second connection side of the mixing device.

The invention is described in greater detail in the following with reference to the figures using an exemplary embodiment. The same reference numbers are always used for the same parts in the figures.

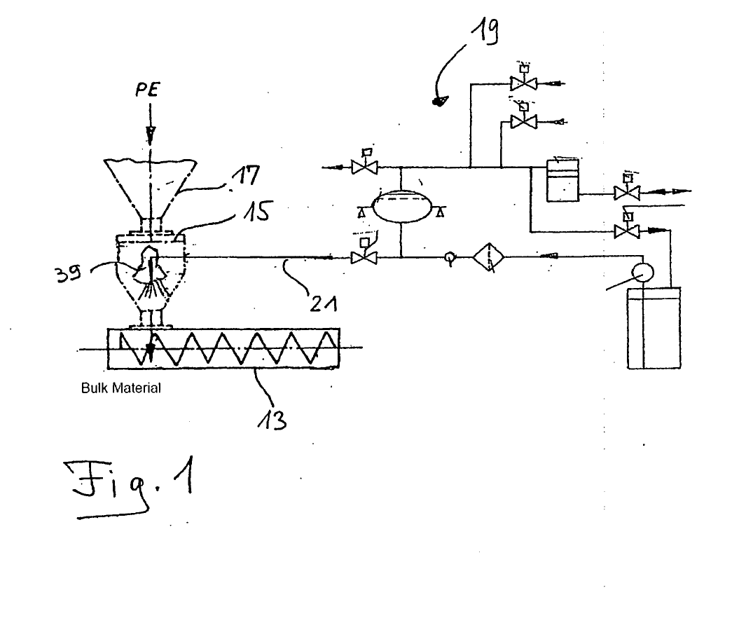

FIG. 1 is a schematic depiction of an extrusion apparatus with a feeding device and a continuous casting apparatus;

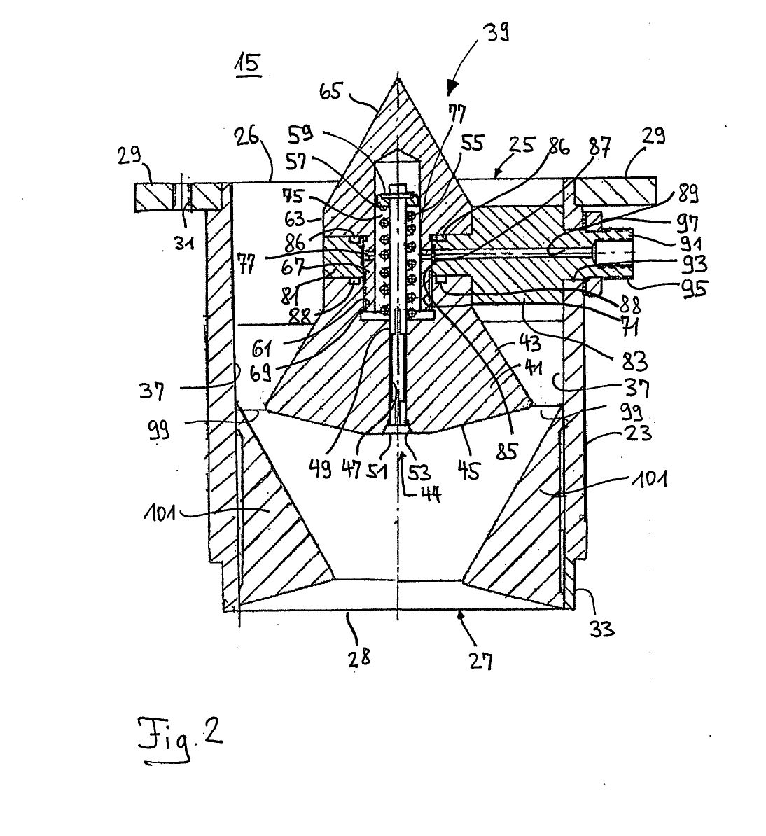

FIG. 2 is a longitudinal section of a first embodiment of an inventive mixing device;

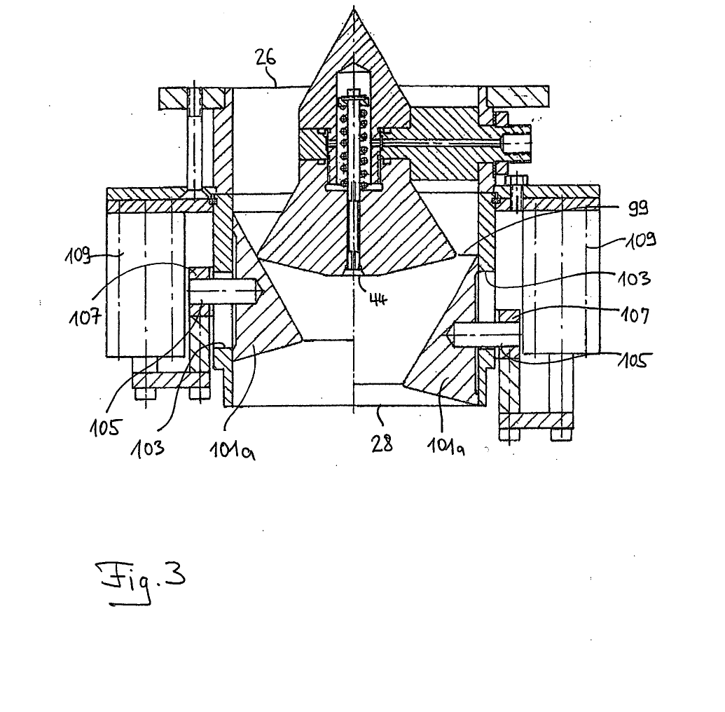

FIG. 3 is a longitudinal section of a second embodiment of an inventive mixing device.

FIG. 1 depicts the basic structure of an extrusion apparatus 11 having a screw extruder 13 and a mixing device 15 arranged on the screw extruder 13. Provided on the mixing device 15 is a feeding device 17 that receives a plastic granulate. Furthermore, a feed line 21 that is for a liquid additive and that comes from a metering device 19 opens into the mixing device 15.

In accordance with a first embodiment, the mixing device 15 possesses a tube segment 23 having a first connection side 25 for the feeding device 17 and a second connection side 27 for the screw extruder 13. The first connection side 25 having the inlet 26 possesses a flange 29 with round holes 31 for detachably fastening to the feeding device 17. The second connection side 27 having the outlet 28 comprises an adapter 33 that can engage in a corresponding element of the screw extruder 13 (not shown in the figures). It is conceivable that a (mechanical) mixer (stirrer) is provided between the mixing device and the screw extruder.

The mixing device 15 shown having the tube segment 23 defines a passage 37 defined for a plastic granulate. An injection apparatus 39 is arranged in the passage 37. The injections apparatus 39 possesses a core 41 in which an injection nozzle 43 having an outlet 44 is arranged. The core 41 has an exterior cone-shaped segment 43 and a convex face 45. Provided in the center of the face 45 is a round hole 47 in which the tappet 49 of the injection nozzle 43, embodied as a valve, is guided in an axially movable manner. The tappet 49 possesses a plate-shaped head 51 that, when the injection nozzle is in the closed state, is received in a positive fit in a correspondingly embodied valve seat 53 of the core 41. The tappet 49 is pre-stressed in the closed position by a spring 55. For this purpose, a ring 57 is placed on the back end of the tappet 49 and is positioned against a clamping disk 59 when the spring 55 is on the tappet.

The back side of the core 41 has a round central threaded bore 61 into which a valve housing 63 is screwed. The valve housing 63 has a pyramidal head 65 and a shaft 67 connecting thereto. The shaft 67 possesses a male thread 69 that can cooperate with the female thread 71 of the threaded bore 61. The valve housing 63 possesses a bore 73 that defines an interior space 75. The rear part of the valve tappet 49 with the spring 55 is received in the interior space 75.

A plurality of radial through-openings 77 is provided distributed about the circumference of the shaft in the top part of the shaft 67. The part of the shaft 67 projecting out of the bore 73, is received in a connecting flange 81 of a connection piece 83. The connecting flange 81 is placed on the back side of the core 41. Sealing rings 86, 88 seal the contact surfaces between the connecting flange 81 and the core 41 in terms of the head 65. The connecting flange 81 possesses a round hole 85 in which the upper part of the shaft 67 is received. Provided in the round hole 85 is an annular groove 87 into which a feed channel 89 of the connection piece 83 opens. The connection piece 83 possesses a connection adapter 91 that is inserted into a hole 93 in the wall of the tube segment 23. A male thread 95 is provided on the connection adapter 91 and a threaded nut 97 can be screwed thereon for attaching the connection piece 83 to the tube segment 23.

The core 41 of the injection apparatus 39 has a diameter such that remaining between its widest diameter and the tube segment 23 is an annular gap 99 for the plastic granulate to pass through. A funnel-shaped guide piece 101 is provided in the tube segment 23 below the core 41. It conducts the plastic granulate that pours down through and is separated by the annular gap 99 under the outlet 44 of the nozzle 43 so that the plastic granulate is wetted well and uniformly.

The second exemplary embodiment in accordance with FIG. 3 is distinguished from the first in that the funnel-shaped guide piece 101a is displaceably arranged on the tube segment 23. The funnel-shaped guide piece 101a is displaceable is [sic] from a closed position (depiction on the left side), in which the annular gap 99 is closed, to an open position (depiction on the right side), in which there is an annular gap 99.

Longitudinal holes 103 that oppose one another are provided in the jacket of the tube segment 23. Bolts 105 pass through the longitudinal holes and are screwed into the funnel-shaped guide piece 101a and are inserted into the mounts 107. The mounts 107 are suspended on repositioning devices 109, e.g. compressed air cylinders.

During operation, plastic granulate is added to the feeding device and, where necessary, weighed. From the feeding device, the plastic granulate travels into the mixing device. As long as the funnel-shaped guide piece 101a is in the top end position, the plastic granulate is prevented from passing through. As soon as the guide piece 101a is moved downward into the open position, the granulate travels through the annular gap 99 into the passage 37. At the same time that the annular gap opens, liquid additive is sprayed through the nozzle into the passage, where it wets the plastic granulate. Pressure actuation can be used to control the quantity of the additive added. The higher the pressure that is exerted on the liquid additive, the greater the quantity of liquid added per unit of time. Thus the pressure actuation and the width of the annular gap can be modified for maintaining the optimum ratio of granulate to additive.

Although the invention was described with respect to a specific application, it is clear to a reader skilled in the art that the inventive method and the inventive apparatus can be used for wetting any desired free-flowing bulk material with a liquid. Also, the outlet side of the described apparatus can be connected directly to a screw extruder or mechanical mixer. The inventive method and the inventive apparatus can be used both for continuous or for batch-wise addition of a liquid to a bulk material.

### REFERENCE NUMBERS

11 Extrusion apparatus
12 Screw extruder
15 Mixing device
17 Feeding device
19 Metering device
21 Feed line
23 Tube segment
25 First connection side for feeding device
26 Inlet
27 Second connection side for screw extruder
28 Outlet
29 Flange
31 Round holes
33 Adapter
37 Passage
39 Injection apparatus
41 Core
43 Cone-shaped section
45 Convex face
47 Round hole
49 Tappet
51 Head
53 Valve seat
55 Spring
57 Ring
59 Clamping disk
61 Central threaded bore in core
63 Valve housing
65 Pyramidal head
67 Shaft
69 Male thread
71 Female thread
73 Bore
75 Interior space
77 Through-openings
79
81 Connecting flange
83 Connection piece
85 Round hole
87 Annular groove
89 Feed channel
91 Connection adapter
93 Hole in the wall of the tube segment
95 Male thread
97 Threaded nut
99 Annular gap
101 Funnel-shaped guide piece
103 Longitudinal holes
105 Bolts
107 Mounts
109 Positioning devices

1-12. (canceled)

13. A method for mixing a free-flowing bulk material with a liquid, comprising using an injection apparatus which is arranged in the center of a tube segment that feeds said bulk material and wherein said bulk material is conducted through an end-face inlet into said tube segment and which is at least partially wetted with a liquid, wherein the outlet of said injection apparatus is arranged above a funnel-shaped guide piece.

14. The method according to claim 13, further comprising arranging said injection apparatus such that a gap for said bulk material to pass through is present between said injection apparatus and said tube segment.

15. The method according to claim 13, further comprising arranging said gap into an annular gap.

16. The method according to claim 15, further comprising setting a width of said annular gap as a function of the physical parameters of said liquid and said bulk material.

17. A mixing device comprising a tube-shaped tube segment defining a passage and having:
a first connection side, having an inlet for connecting a feed device for a pourable solid;
a second connection side, having an outlet for connecting to a continuous casting apparatus or a mechanical mixer;
an injection apparatus arranged in the center of said passage for a liquid additive, the outlet being oriented in the direction of flow of said bulk material; and
a funnel-shaped guide piece provided in said passage of said mixing device, wherein said outlet of said injection apparatus is arranged above said funnel-shaped guide piece.

18. The mixing device of claim 17, further comprising a gap for said bulk material to pass through, wherein said gap is present between said injection apparatus and said tube segment.

19. The mixing device of claim 18, wherein said gap is an annular gap present between said injection apparatus and a jacket of said tube-segment.

20. The mixing device of claim 17, wherein said injection apparatus possesses a core and a nozzle arranged on the bottom of said core.

21. The mixing device of claim 17, wherein the guide piece is provided below said injection apparatus.

22. The mixing device of claim 21, wherein said guide piece is displaceable in said tube segment.

23. The mixing device of claim 21, wherein said core and said guide piece can be moved from an open position relative to one another, in which an annular gap is formed in said tube segment, to a closed position, in which said passage for said bulk material is blocked.

24. An apparatus for producing extruded products made of a granulate polymer, the apparatus comprising:
a mixing device comprising a tube-shaped tube segment defining a passage and having:
a first connection side, having an inlet for connecting a feed device for a pourable solid;
a second connection side, having an outlet for connecting to a continuous casting apparatus or a mechanical mixer;
an injection apparatus arranged in the center of said passage for a liquid additive, the outlet being oriented in the direction of flow of said bulk material; and
a funnel-shaped guide piece provided in said passage of said mixing device, wherein said outlet of said injection apparatus is arranged above said funnel-shaped guide piece;
a feeding device for at least one polymer provided on, or connected to, said inlet of said mixing device; and
a continuous casting apparatus provided on, or connected to, said outlet of said mixing device.
